(19) United States
(12) Patent Application Publication
(10) Pub. No.: US 2006/0008571 A1
(43) Pub. Date: Jan. 12, 2006

(54) Method of producing an uncooked pressed cheese paste and paste thus obtained

(75) Inventors: Jean-Claude Walchli, Condat en Feniers (FR); Pierre Walchli, Condat en Feniers (FR)

Correspondence Address: OLIFF & BERRIDGE, PLC, P.O. BOX 19928, ALEXANDRIA, VA, 22320, US

(73) Assignee: WALCHLI S.A., Condat en Feniers (FR)

(21) Appl. No.: 10/530,573

(22) PCT Filed: Oct. 8, 2003
(86) PCT No.: PCT/FR03/02970

§ 371 Date: Jun. 6, 2005

(30) Foreign Application Priority Data
Oct. 8, 2002 (FR) 02/12479

(51) Int. Cl. A23C 19/00

(52) U.S. Cl. 426/582

(57) ABSTRACT

The invention relates to a method of producing an uncooked pressed cheese paste, comprising the following steps: a curd is obtained from the coagulation of raw milk and/or milk which has been seeded with ferments; the curd is pressed in order to produce a volume of tomme; the tomme is left to stand for a first maturation phase; the tomme is ground to produce grains of tomme; the tomme is left to stand for a second maturation phase; the tomme is broken up to produce grains of tomme; the salted grains of tomme are poured into a tubular moulding machine with a vertical axis, comprising at least one tubular column; and, finally, the grains of tomme are pressed in the aforementioned column in order at least to form one tube shape which can be cut into portions. The cheese paste thus obtained can be plain, salty, sweet or flavoured or contain fruit extracts.

The present invention relates to a method of producing an uncooked cheese paste which has been subjected to double pressing and to double maturation, ready to be cut into portions.

The description of the invention will be made more particularly with reference to a Cantal or Cheddar type cheese, but the invention extends to any uncooked, salted, sweetened, plain and/or variously flavored cheese paste.

The designation of origin “Cantal” is reserved for cheeses which comply with the provisions of the current legislation defined in the CANTAL Decree of 29/12/86, which determines in particular the geographic area within which the milk must be produced and the cheeses manufactured, certain characteristics such as the fat content and the dry matter content of the cheeses, and their presentation. More generally, Cantal belongs to the family of pressed, uncooked cheeses, to which Salers of the same territory, but also Cheddar, also belong.

These cheeses are obtained by ancestral methods mainly comprising the steps described below.

Starting with milk which is either raw, or pasteurized and seeded with ferments, and then renneted, a curd is obtained which is pressed, for a first pressing phase, in order to expel the whey. This step is carried out by pouring the curd into a draining/pressing tank, and then placed in a cloth where it is compressed under the effect of a tomme press. The yield of this pressing is improved by cutting and turning over the mass several times.

The tomme thus obtained is left to stand for a first fermentation or maturation phase during which the bacterial enzymes degrade the proteins of the tomme, and the sugars, in particular lactose, are converted to lactic acid. This step lasts for about 8 to 16 hours and is carried out under precise temperature conditions, namely between 16 and 22° C., and precise ventilation and humidity conditions.

The characteristic feature of this paste consists in the fact that it is subjected to a new maturation/ pressing cycle. To this effect, the tomme is cut up and then ground in a tomme mill, for example, at the same time as salt, in the dry state, is added. Optimum salting within the mass is achieved by repeated mixing of the grains of tomme with salt. The salted grains of tomme are left to stand, during a second maturation phase, for about 6 to 12 hours. During this phase, exudation of the whey continues by osmosis because of the salt concentration and under the effect of the lowering of the pH, and a natural compaction of the tomme occurs with joining up of the grains of tomme. The acidity of the whey is regularly measured, and the second maturation phase is completed when this acidity reaches a value in the region of 100 degrees Dornic (° D). The tomme thus obtained is dispersed either manually or by another passage through the tomme mill, and poured into moulds in successive layers, after each of which the tomme is compacted manually or automatically. The moulds are advantageously equipped with microperforated plastic walls comprising an inner weft so as to avoid the traditional use of linen cloth which requires being tentered, being changed as a result of being too wet during the second maturation phase. A follower is then placed on each of the tommes in order to apply pressure thereto, and they are left to stand in order to complete the lactic fermentation process.

The tommes thus obtained, which have been subjected to maximum purification, have minute contents of fermentable sugars and of whey.

The cheese then enters a ripening process, during which the color and the texture of the paste, the appearance of the rind and the flavors will change through enzymatic action. Precise temperature and moisture conditions are required. Depending on the quality of the cheese, the ripening may last for 1 to 4 months, or even longer.

The cheese with the designation “Cantal” is provided in the form of a cheese loaf having a weight varying from 35 to 45 kg; two variants having this designation and called “Petit Cantal” and “Cantalet” have a weight of 15 to 20 kg, and from 8 to 10 kg, respectively.

For the marketing of this type of cheese, either the cheese loaves are sent to prepackaging plants, or they are stored in a cold room, at the retailer's for the “cutting” section.

It is evident from this method of manufacture that this type of pressed, uncooked cheese, resulting from at least two pressing/maturation cycles, is available in only one heavy and voluminous format whose distribution is difficult. At the retailer's, the storage of this cheese for a long period according to the turnover poses a problem if the preservation is not provided for under appropriate conditions.

To open another outlet for the consumption of this type of cheese, the applicant has developed a method which solves the abovementioned problems.

According to this method, a cheese is obtained which, while preserving all the biological and organoleptic qualities of the Cantal cheese, becomes available in a variable and prepackaged format after observing in particular the double pressing/fermentation characteristic of this cheese.

As previously stated, the invention applies to the production of a cheese mentioned above, but is also suitable for the production of a paste which is unsalted and/or not necessarily ripened. Thus, according to the invention, it is possible to obtain a sweetened, salted plain cheese paste which may be additionally flavored for example with gentian extract, or may be supplemented with nut or any other fruit or fruit extract. The paste may also be seeded with latent penicilliums capable of developing at any predetermined moment by exposure to oxygen. These penicilliums are commercially available and may be added at any stage of the process, for example they are added to the starting milk, or to the paste.

The resulting product may be provided as blocks ready to be cut or as individual portions, to be used for example in case, as a calcium-rich food supplement.

The heart of the invention consists mainly in a modification of the second pressing phase described above, without its efficiency being thereby affected.

A first subject of the invention is a method of producing an uncooked pressed cheese paste comprising the following steps:
a curd is obtained from the coagulation of a raw and/or pasteurized milk and milk which has been seeded with ferments,
the curd is pressed in order to produce a volume of tomme,
the tomme is left to stand for a first maturation phase,
the tomme is ground to produce grains of tomme,
the tomme is left to stand for a second maturation phase,
the tomme is broken up to produce grains of tomme,
the salted grains of tomme are poured into a tubular molding machine with a vertical axis, comprising at least one tubular column, and the grains of tomme are pressed in said column in order at least to form therein a roll ready to be cut.

The step of passing the salted grains of tomme into the molding machine provides the second pressing phase.

According to a variant of the method, the roll is divided, at the bottom of the column, in several vertical dies, in order to obtain, at the outlet of the die, blocks of paste ready to be cut.

The roll or the blocks of paste thus obtained may be immediately cut and packaged, which has the advantage of incorporating the packaging step into the preparation process, without disrupting the production line.

The cut portions are preferably packaged in thermo-formed plastic tubs sealed with a film which is permeable to atmospheric oxygen to a greater or lesser degree, or under a modified atmosphere, or in heat-sealed plastic bags comprising at least one transparent side which makes the packaged product visible. This packaging step is preferably carried out at a temperature in the region of that of the site of storage of the final product, generally a cold room.

It is therefore in the packaging that the ripening of the paste occurs, and the examples will demonstrate that the biochemical characteristics of the cheese are similar to those of Cantal. In order to obtain optimum ripening, it is advantageous to package the portions of cut cheese under a nitrogen/oxygen gas mixture in which the oxygen content varies according to the desired ripening.

According to the invention, and in particular for any product not intended for proteolysis, it is possible to prevent the ripening from taking place. To this effect, either the cheese paste or the cut portion will be subjected, before or after packaging, to an antibacterial treatment. Such a treatment is chosen from those already used in the food sector and well known to persons skilled in the art; by way of example, there may be mentioned ionization and sterilization applied to pasty products.

In a preferred variant of the invention, the cheese paste is salted, and the cheese obtained is of the Cantal type. The only characteristic which distinguishes it from Cantal is the absence of rind. In Cantal, the rind associated with the ripening conditions promotes drying of the cheese loaf which progresses from the outside to the inside and provides additional ripening. According to the invention, no impairment of the ripening is observed because the biological composition of each of the pastes is identical, namely presence of the same types of enzymes which will degrade the same types of proteins, and absence of fermentable sugars and whey. In addition, the moisture of the nonfatty substance is maintained at its initial level.

When it is desired to obtain a Cantal-type cheese according to the invention, the conditions for obtaining the grains of tomme before the second pressing phase may be and are advantageously identical to those for the manufacture of Cantal. In particular:
raw or pasteurized milk and milk seeded with the same type of ferments is used as starting material and it is coagulated with rennet, and/or
the first maturation phase is carried out at a temperature varying from 16-22° C. for a period varying from 8 to 16 hours, and/or
after the first maturation phase, the tomme is ground and salted with dry salt, and/or
the second maturation phase is carried out at a temperature of 16-22° C., for a period varying from 6 to 12 hours.

As indicated above, the tubular molding machine comprises at least one tubular column whose lower end may open into a multiplicity of vertical dies in which the second pressing phase for the paste will be continued. The passage of the paste into the column(s) of the molding machine, and then into the dies is carried out under the action of a follower capable of sliding into said columns. By way of example, the surface area at the base of the column is between 20 and 400 cm², and the pressure is applied in a range from 0.5 to 2 bar.

In order to promote the final exudation of the whey during the second pressing of the paste, the walls of said columns of the molding machine and of the dies are advantageously microperforated, for example in the form of micropores and/or longitudinal micro-openings.

The lower end of the columns of the molding machine and that of the dies is advantageously extended by a cooling jig which can be adjusted for the cutting height and comprising knives.

Once cut, the portions will be continuously conveyed through a clean room type chamber up to the packaging point.

The examples below illustrate the qualities of a cheese obtained according to the invention compared with those of Cantal.

### EXAMPLE 1

Biological analysis of a cheese obtained according to the method of the invention on D0 corresponding to the date of packaging of the cheese on coming out of the molding machine, and after 10 days (D+10), 17 (D+17), 38 days (D+38) and 100 days (D+100) of ripening in plastic packaging.

| | Total dry | | | | Salt |
|---|---|---|---|---|---|
| | extract | Fat | | | level |
| Samples | (TDE)/100 g | (F)/100 g | F/TDE | pH | (in %) |
| D + 10 | 63.50 | 30.25 | 47.90 | 5.21 | 2.15 |
| D + 17 | 63.41 | 29.75 | 46.91 | 5.16 | 2.10 |
| D + 38 | 63.24 | 31.75 | 50.20 | 5.50 | 2.10 |
| D + 100 | 62.82 | 31.00 | 49.30 | 5.30 | 1.70 |

According to article 2 of the CANTAL Decree of 29/12/86, cheeses which have the designation of origin “Cantal” are double-pressed uncooked hard cheeses with a dry rind which are manufactured with renneted cow's milk, with grinding of the curd between the two pressings, salted within the mass, containing a minimum of 45 g of fat per 100 g of cheese after complete desiccation (F/TDE ratio) and whose dry matter content should not be less than 57 g per 100 g of ripened cheese, and more particularly 56% minimum at 30 days.

It is observed that these two parameters defined for a paste according to the invention are in accordance with the provisions of the CANTAL Decree.

### EXAMPLE 2

Microbiological analysis of a cheese obtained according to the method of the invention on D0 corresponding to the date of packaging of the cheese on coming out of the molding machine, and after 10 days (D+10), 17 days (D+17) and 68 days (D+68) of ripening in plastic packaging.

| | | Results | | |
|---|---|---|---|---|
| | | | D + 10 | |
| | Method of | Cantal tomme | D + 17 | |
| Microorganisms | determination | 247 | D + 38 | D + 68 |
| Aerobic | NF V 08051-D0 | >300 000 000/g | >300 000 000/g | >300 000 000/g |
| microorganisms 30° C. | 17.05.94 | | | |
| Escherichia coli | V 08 053 | 20 en* | >15 000/g | >15 000/g |
| β glucuronidase+ | | | | |
| Salmonella | NF V08 052 | | absence/25 g | absence/25 g |
| Staphylococci | V 08 057-1 | <10/g | <100/g | <10/g |
| coagulase+ | | | | |
| Listeria | NF EN ISO | | absence/25 g | absence/25 g |
| monocytogenes | 11290-1 at 37° C. | | | |

*en is the estimated number of colonies counted at the first dilution

These analyses are in accordance with those required for cheese with the designation Cantal.

1. A method of producing an uncooked pressed cheese paste comprising the following steps:
a curd is obtained from the coagulation of a raw and/or pasteurized milk and milk which has been seeded with ferments,
the curd is pressed in order to produce a volume of tomme,
the tomme is left to stand for a first maturation phase,
the tomme is ground to produce grains of tomme,
the tomme is left to stand for a second maturation phase,
the tomme is broken up to produce grains of tomme, said method being characterized in that
the salted grains of tomme are poured into a tubular molding machine with a vertical axis,
comprising at least one tubular column, and
the grains of tomme are pressed in said column in order at least to form therein a roll ready to be cut.

2. The method as claimed in claim 1, characterized in that said roll is divided at the bottom of the column in several vertical dies so as to obtain, at the outlet of the die, blocks of paste ready to be cut.

3. The method as claimed in claim 1, characterized in that the roll or the blocks of paste are cut into portions which are packaged individually.

4. The method as claimed in claim 1, characterized in that the grains of tomme are pressed by means of a follower adapted to slide into the tubular column(s).

5. The method as claimed in claim 1, characterized in that the wall of the column(s) and/or that of the vertical dies are microperforated.

6. The method as claimed in claim 1, characterized in that the lower part of the column(s) or of the dies is extended by a cooling jig.

7. The method as claimed in claim 6, characterized in that the cooling jig comprises knives.

8. The method as claimed in claim 6, characterized in that the cooling jig can be adjusted for the cutting height of the paste.

9. The method as claimed in claim 1, characterized in that the cheese paste is flavored and/or supplemented with intermediate products, optionally ground and/or seeded with latent penicilliums.

10. The method as claimed in claim 1, characterized in that the paste, or the portions, before or after packaging, are subjected to an antibacterial treatment.

11. The method as claimed in claim 10, characterized in that said treatment is chosen from ionization and sterilization.

12. The method as claimed in claim 1, characterized in that the cheese paste is salted and in that it consists of a Cantal-type cheese.

13. The method as claimed in claim 12, characterized in that the milk is renneted.

14. The method as claimed in claim 12, characterized in that the first maturation phase is carried out at a temperature of 16-22° C., for a period varying from 8 to 16 hours.

15. The method as claimed in claim 12, characterized in that, after the first maturation phase, the tomme is ground and salted with dry salt.

16. The method as claimed in claim 12, characterized in that the second maturation phase is carried out at a temperature of 16-22° C. for a period varying from 6 to 12 hours.

17. An uncooked pressed cheese paste which can be obtained by the method as claimed in claim 1.

18. An uncooked pressed cheese paste portion which can be obtained by the method as claimed in claim 3.
